(19) United States
(12) Patent Application Publication
(10) Pub. No.: US 2021/0185791 A1
(43) Pub. Date: Jun. 17, 2021

(54) Reusable Container For Electronics And Consumables

(71) Applicant: Xerox Corporation, Norwalk, CT (US)

(72) Inventors: Cheryl A. Nazzaro, Fairport, NY (US); Sanja Pstrocki-Porras, Rochester, NY (US)

(73) Assignee: Xerox Corporation

(21) Appl. No.: 16/716,937

(22) Filed: Dec. 17, 2019

(51) Int. Cl. H05F 1/00; B65D 25/04

(52) U.S. Cl. CPC H05F 1/00; B65D 25/04

(57) ABSTRACT

A reusable container for electronic articles including an exterior formed of exterior surfaces; an interior formed of interior surfaces; at least one electronic interior compartment for containing an electronic article; at least one non-electronic interior compartment for containing a non-electronic article; wherein an interior surface of the at least one electronic compartment comprises an electronic protective surface; and wherein the electronic protective surface is an integral part of the container; and wherein the non-electronic interior compartment does not include an electronic protective surface. A method for using the container.

### BACKGROUND

Disclosed herein is a reusable container for electronic articles and related consumables comprising an exterior formed of exterior surfaces; an interior formed of interior surfaces; at least one electronic interior compartment for containing an electronic article; at least one non-electronic interior compartment for containing a non-electronic article; wherein an interior surface of the at least one electronic compartment comprises an electronic protective surface; and wherein the electronic protective surface is an integral part of the container; and wherein the non-electronic interior compartment does not include an electronic protective surface.

Also disclosed is a method for using a reusable container for electronic articles, the method comprising employing a reusable container including an exterior formed of exterior surfaces; an interior formed of interior surfaces; at least one electronic interior compartment for containing an electronic article; at least one non-electronic interior compartment for containing a non-electronic article; wherein an interior surface of the at least one electronic compartment comprises an electronic protective surface selected for the electronic article; and wherein the protective surface is an integral part of the container; and wherein the non-electronic interior compartment does not include an electronic protective surface; inserting one or more electronic articles into one or more of the at least one electronic interior compartments; inserting one or more non-electronic articles into the one or more of the at least one non-electronic interior compartments; transporting the reusable container to a first location; removing one or more of the electronic articles or non-electronic articles; refilling one or more of the at least one electronic interior compartments or the at least one non-electronic interior compartments; and transporting the reusable container to a second location.

Disposable waste adds additional overhead and cost to companies shipping items to customers. Disposable waste is also a big environmental concern. Reducing disposable waste, such as plastic and cardboard packaging materials, will continue to be important as we become more aware of the effects disposable waste causes on the environment. If legislation is passed to reduce or penalize the use of throw-away materials including packaging materials, businesses will need to develop new ways to package and ship items in a more sustainable way.

Currently, items requiring specialized handling are packaged individually. For example, customers may receive multiple boxes, bags, and packaging materials with orders including antistatic sleeves and bags, boxes with Styrofoam®, packing peanuts, bubble wrap, and the like. FIG. 1 illustrates a prior art package 10 including paper covering 12, top and bottom foam packaging pieces 14 and 16, and plastic bag 18 inside which is one or more additional bags (unnumbered) enclosing paperwork, protective coverings, and an electronic device or part. FIG. 2 illustrates another view of prior art package 10 with top protective foam piece 14 removed and showing plastic bag 18 and additional plastic bags (not numbered) underneath. FIG. 3 illustrates another view of prior art package 10 with some of the plastic bags including bag 18 removed from the container 10. If recycling is desired or required, the customer must spend time sorting and disposing of items. It is desirable to reduce disposable waste associated with the packaging required for shipping and returning items such as electronics and consumables.

Currently available containers may be suitable for their intended purposes. However a need remains for improved containers. Further, a need remains for improved reusable containers suitable for electronics and consumables that reduces or eliminates disposable waste. Further, a need remains for a reusable container that provides ESD protection for electronic parts and devices. Further, a need remains for a reusable container that provides ESD protection for electronic parts and related consumables where the container can be reused, and, in embodiments, reconfigured, for transporting electronic parts, related consumables, and for returning such parts, or reusing the container to transport other materials.

The appropriate components and process aspects of the each of the foregoing U. S. patents and patent Publications may be selected for the present disclosure in embodiments thereof. Further, throughout this application, various publications, patents, and published patent applications are referred to by an identifying citation. The disclosures of the publications, patents, and published patent applications referenced in this application are hereby incorporated by reference into the present disclosure to more fully describe the state of the art to which this invention pertains.

### SUMMARY

Described is a reusable container for electronic articles comprising an exterior formed of exterior surfaces; an interior formed of interior surfaces; at least one electronic interior compartment for containing an electronic article; at least one non-electronic interior compartment for containing a non-electronic article; wherein an interior surface of the at least one electronic compartment comprises an electronic protective surface; and wherein the electronic protective surface is an integral part of the container; and wherein the non-electronic interior compartment does not include an electronic protective surface.

Also described is a method for using a reusable container for electronic articles, the method comprising employing a reusable container including an exterior formed of exterior surfaces; an interior formed of interior surfaces; at least one electronic interior compartment for containing an electronic article; at least one non-electronic interior compartment for containing a non-electronic article; wherein an interior surface of the at least one electronic compartment comprises an electronic protective surface selected for the electronic article; and wherein the protective surface is an integral part of the container; and wherein the non-electronic interior compartment does not include an electronic protective surface; inserting one or more electronic articles into one or more of the at least one electronic interior compartments; inserting one or more non-electronic articles into the one or more of the at least one non-electronic interior compartments; transporting the reusable container to a first location; removing one or more of the electronic articles or non-electronic articles; refilling one or more of the at least one electronic interior compartments or the at least one non-electronic interior compartments; and transporting the reusable container to a second location.

### BRIEF DESCRIPTION OF THE DRAWINGS

FIG. 1 is an illustration of a prior art package.

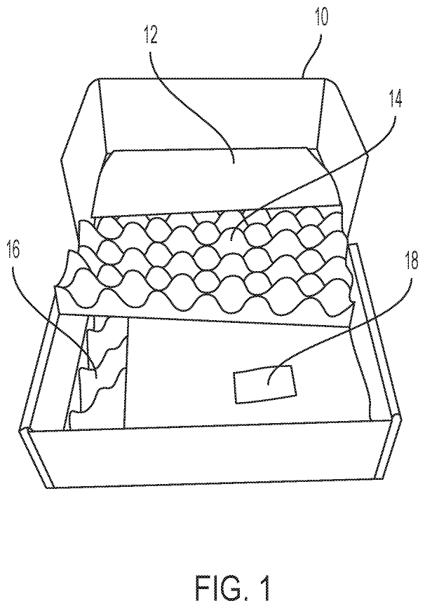

FIG. 2 is an alternate view of the prior art package of FIG. 1.

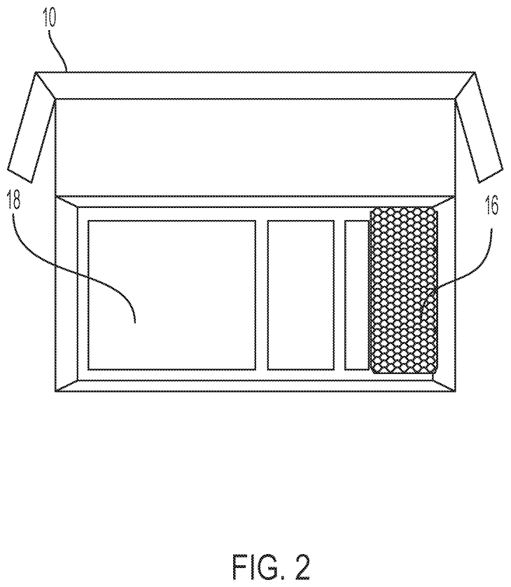

FIG. 3 is an alternate view of some of the contents of the prior art package of FIG. 1.

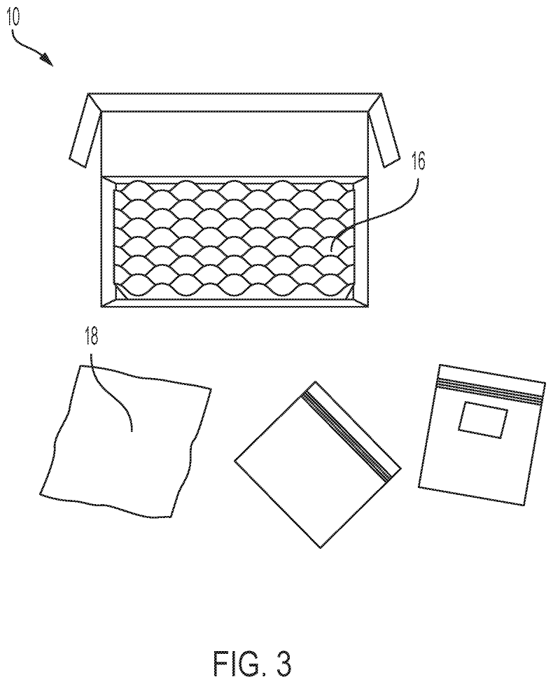

FIG. 4 is an illustration of a reusable container in accordance with the present disclosure.

FIG. 5 is an illustration of a reusable container in accordance with the present disclosure.

FIG. 6 is an illustration of another embodiment of a reusable container in accordance with the present disclosure.

### DETAILED DESCRIPTION

A reusable container for electronics and consumables is provided which reduces disposable waste previously associated with packaging and shipping. In embodiments, a reusable container is provided comprising specialized compartments which compartments include specialized linings, materials, coatings, or a combination thereof designed for the intended contents, where the materials or coatings are an integral part of the container. The container can be used for transporting, such as hand carrying or shipping, any suitable or desired articles, in embodiments, electronic parts and related consumables. The container reduces the number of packaging materials required for a given shipment. Previously, for example, a shipment might require a box containing toner and a bag containing electronics, both packaged in bags placed inside a box with protective filler and the like. The present embodiments provide a single container which may contain parts or consumables that the recipient, such as a CSE (customer service engineer), technician, or customer can return to the company for recycling.

Thus, a single reusable container is provided, which can be used, in embodiments, for electronics and consumables, as well as any other material or component to be shipped. The present single reusable container reduces packaging waste, reduces shipping costs, and makes it easier for recipients to return items, such as for recycling, while providing a container that includes an electronic protective compartment for electronic parts.

In embodiments, a reusable container for electronic articles herein comprises an exterior formed of exterior surfaces; an interior formed of interior surfaces; at least one electronic interior compartment for containing an electronic article; at least one non-electronic interior compartment for containing a non-electronic article; wherein an interior surface of the at least one electronic compartment comprises an electronic protective surface, such as an ESD protective surface or an RFID (radio frequency identification) blocking surface; and wherein the electronic protective surface is an integral part of the container; and wherein the non-electronic interior compartment does not include an electronic protective surface.

The exterior and interior surfaces of the reusable container form any suitable or desired container shape. In embodiments, the reusable container is square, rectangular, oval, or round shaped.

The reusable container may be formed from any suitable or desired material. In embodiments, the reusable container is formed from cardboard, corrugated cardboard, plastic, wood, or a combination thereof.

The reusable container may be of any suitable or desired form. That is, the reusable container may comprise a crate, a bag, a file folder, a folder, or a box.

In embodiments, the reusable container comprises a box, such as a rectangular box, although not limited to rectangular shape but rather can be any desired shape, which when in a cube shape the box has opposing, parallel length-wise sides connecting on either end to opposing, parallel width-wise sides. Top flaps extending outward from top edges of each of the four box sides can be folded toward each other to form the top of the box, as is typical for cardboard boxes. Similarly, bottoms flaps extending outward from bottom edges of each side can be folded toward each other to form the bottom of the box in a customary fashion. The bottom flaps and tops flaps are usually taped in place to establish the top and bottom of the box in a cube shape, but the top and bottoms flaps can be secured in place by any suitable or desired method, such as by forming the flaps with male-female portions, or other known method for securing. One or more dividers, flaps, or extension portions may be included to form interior compartments. In certain embodiments, a reusable container herein comprises an outer semi-rigid corrugated box providing a top wall, a bottom wall, and a plurality of side walls, the box having a plurality of corrugated flaps each being connected to a corresponding side wall for forming said top and bottom walls; one or more interior compartments each having an interior surface; wherein one or more of the interior compartments is lined with a material or coating selected for an article to be contained within the compartment.

In embodiments, the reusable container includes at least one electronic interior compartment, wherein the at least one electronic interior compartment includes a flap or extension portion; wherein the flap or extension portion forms one or more sections or sub-compartments for separating or organizing one or more electronic articles; wherein the flap or extension portion is an integral part of the container; and wherein the flap or extension portion includes the electronic protective surface on at least one surface of the flap or extension portion adjacent to the electronic article.

The reusable container may further include one or more non-electronic interior compartments for containing a non-electronic article. In embodiments, the reusable container includes at least one non-electronic compartment, wherein the at least one non-electronic interior compartment for containing a non-electronic article includes a flap or extension portion; wherein the flap or extension portion is an integral part of the container; wherein the flap or extension portion forms sections for separating or organizing one or more non-electronic articles; and wherein the flap or extension portion does not include an ESD protective surface.

The reusable containers herein include compartments having specialized linings for electronics. For example, the compartments may include ESD (electrostatic discharge) or RFID (radio frequency identification) blocking materials as an integral part thereof.

ESD materials are generally subdivided into categories with related properties: anti-static, conductive, and dissipative. Conductive materials have a low electrical resistance, thus electrons flow easily across the surface or through these materials. Charges go to ground or to another conductive object that the material contacts. Dissipative materials allow the charges to flow to ground more slowly in a more controlled manner than with conductive materials. Anti-static materials are generally referred to as any material which inhibits triboelectric charging. This kind of charging is the buildup of an electric charge by the rubbing or contact with another material. See https://en.wikipedia.org/wiki/Electrostatic_discharge_materials.

The electronic compartments of the reusable container include as an integral part thereof one or more ESD (electrostatic discharge) materials. The ESD material may comprise a lining or a coating that forms a part of the interior of the electronic compartment. The ESD protective surface is provided as an integral part of the electronic compartment in any suitable or desired manner, such as by fusing the ESD protective material to the interior surface of the electronic compartment or by forming the electronic compartment in whole or in part from the ESD blocking material. In embodiments, the ESD protective material may be adhered to the container using an adhesive layer between the container, such as one or more of the interior surfaces of the ESD compartment, and the ESD protective material.

In embodiments, the ESD protective surface comprises an anti-static material, a conductive material, a dissipative material, or a combination thereof. The ESD protective surface is selected in accordance with the electronic article to be contained.

In certain embodiments, the ESD protective surface comprises a coating or lining that is an integral part of the inner electronic compartment and which covers all or a portion of the surface of the inner electronic compartment. In embodiments, the ESD protective surface comprises any of the currently known plastics that reduce static electricity to protect electrostatic-sensitive devices (ESD). Examples of such materials include, but are not limited to, acetal, acetal copolymers, polyvinyl chloride, chlorinated polyvinyl chloride, acrylic, polycarbonate, and the like, and combinations thereof. The present disclosure also contemplates use of any future developed ESD coating or lining material as an integral part of the present reusable container.

The protective surface may comprise an RFID blocking material. Any suitable or desired RFID blocking material may be selected including, but not limited to, metal, such as aluminum, alloy nickel, copper, or other material as known in the art. The RFID protective surface is provided as an integral part of the electronic compartment in any suitable or desired manner, such as by fusing the RFID protective material to the interior surface of the electronic compartment or by forming the electronic compartment in whole or in part from the RFID blocking material. In embodiments, the RFID blocking material can be adhered to the container using an adhesive layer between the container and the RFID blocking material. The present disclosure also contemplates use of any future developed RFID coating or lining material as an integral part of the present reusable container.

The present single reusable container can be used for any combination of items. The interior compartments are configured as necessary for the items to be shipped. In embodiments, one or more interior electronic compartments are provided for containing one or more electronic articles. In embodiments, one or more non-electronic interior compartments are provided for containing one or more non-electronic articles. The interior compartments can be configured to have any suitable or desired shape or size in order to accommodate the article to be contained therein.

For example, one or more ESD lined electronic compartments may be provided for containing one or more electronic articles comprising an electronic part or electronic device. The electronic device or article can be any article where it is desired to provide ESD protection to the article. The electronic device or article can be one used in any suitable or desired industry or for any suitable or desired application. In embodiments, the electronic article is selected from the group consisting of a network card, a memory card, a video card, a hard drive, a power supply, a battery, a mother board, a transistor, a chip, a TTL (transistor-transistor logic) chip, a laser diode, a light emitting diode, a resistor, a medical device, and combinations thereof. In certain embodiments, the electronic article is selected from the group consisting of a network card, a memory card, a hard drive, a power supply, a battery, a mother board, and combinations thereof.

The non-electronic interior compartment can be used for containing any suitable or desired article, in embodiments, for any suitable or desired article that does not require ESD protection. The reusable container may comprise one or more non-electronic interior compartments of any suitable or desired shaped. Non-electronic articles to be contained are not limited. In embodiments, the non-electronic articles are selected from the group consisting of paperwork, instructions, results, invoices, receipts, return address labels, inks, toners, cartridges, medications, supplies, including medical supplies, printing supplies, or any other supplies, and combinations thereof. In certain embodiments, the non-electronic article is selected from the group consisting of paperwork, instructions, invoices, ink, toner, cartridges, and combinations thereof.

In embodiments, the single reusable container can be used in a business environment such as where a customer is to receive a board for evaluation and will return the board after evaluation. The container in this embodiment comprises an ESD (electrostatic sensitive device) compartment and a documentation compartment. The board and documentation are thus packaged in a single reusable container. The board is protected in the ESD compartment. Packaging in this example is reduced up to 50 percent over prior packaging methods. Once the evaluation is complete, the customer repackages the board in the ESD compartment, the box (single reusable container) is resealed, and sent back to the company. Advantageously, there is no need for additional packaging as previously required. In the present embodiments, the toner cartridge is placed in the specialized toner compartment which holds the toner cartridge without the need for any other packaging. The toner cartridge is locked into the specialized compartment for secure transport.

In other embodiments, the single reusable container can be used to package toner that will be returned to a company for credit or to be refilled. In this application, a customer orders replacement toner. The company puts the toner in a single reusable container and sends the container to the customer without additional packaging material as previously required. The customer receives the toner and, in embodiments, puts empty toner bottles in the single reusable container and returns to the company for credit or to be refilled.

Using the present single reusable containers, modified based on the contents, is a green implementation for shipping and returning any device or material and provides a reduction in disposable waste while saving both the recipient, such as a consumer, and the supplier money.

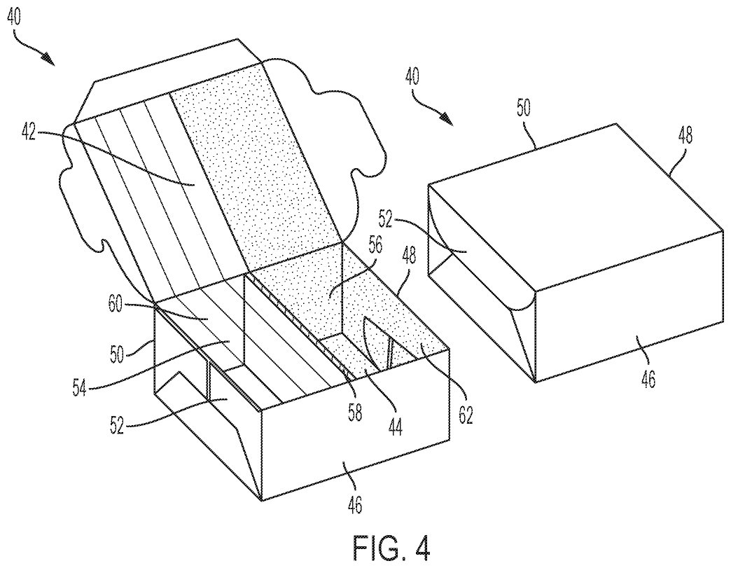

FIG. 4 illustrates a general embodiment of the single reusable container of the present disclosure. The reusable container 40 shown in FIG. 4 may be any suitable or desired material. The interior of top wall 42 and bottom 44 can be seen in FIG. 4. Side walls 46, 48, 50, and 52 provide the outer and inner walls of the container 40. Two or more interior compartments 54, 56 are divided by interior wall 58. Interior compartment 54 comprises a selected coating 60. Interior compartment 56 comprises another selected coating 62. The coatings 60 and 62 can be the same or different depending on the electronic article to be contained in the compartment. In embodiments, the inside of top wall 42 can be lined with one or more coatings such as half lined with coating 60 and half lined with coating 62 to correspond with the two interior compartments. Coatings 60 and 62 form an integral part of the interior compartments 54, 56. The coatings 60 and 62 may be provided in the form of a lining or coating or may be a material that forms the interior compartment itself.

In another embodiment, the container 40 can include one or more additional interior top walls (not shown) attached to one or more of the side walls 46, 58, 50, 52 and which interior top walls can optionally include a selected coating.

The container 40 may include any number and configuration of interior compartments by including any number of interior walls. The walls may be fixed, movable, or expandable. One or more flaps or extension portions may be included in a manner similar to dividing wall 58 to form one or more sections or sub-compartments for separating or organizing one or more electronic articles or form containing one or more non-electronic articles, where the flap or extension portion, when forming one or more sections or sub-compartments for electronic articles, includes the electronic protective surface on at least one surface of the flap or extension portion adjacent to the electronic article. The one or more flaps or extension portions may be of any length or size as desired for the intended article. The one or more flaps or extension portions may be disposed within the container, or may comprise an integral part of the container, for example, may comprise part of a box blank, or may be a removable flap or extension which is inserted into the container and which may be connected to one or more walls of the container by any suitable or desired means, such as by adhering with adhesive, or by attaching with a hook and loop type fastener, or any other suitable or desired method.

The container illustrated in FIG. 4 is shown in the form of a box shaped container. However, the present disclosure includes any desired container as described above, including, but not limited to, crates, bags, folders, file folders, boxers, or other types of containers. In embodiments, the reusable container herein comprises a compartmented crate, a compartmented bag, a compartmented folder, a compartmented box, or a combination thereof. For example, container 40 may be in the form of a folder having interior dividers forming any selected number of compartments. The compartments may comprise any desired combination of ESD and non-ESD compartments. The folder may include any desired number of dividers or walls which may be fixed, movable, or expandable. Similarly, container 40 may be in the form of a bag having any selected number of interior compartments comprising any desired combination of ESD and non-ESD compartments. When used herein, ESD is mentioned specifically, but it is meant that the protective surface can be any specialized electronic protective surface including, but not limited to, ESD and RFID blocking surfaces. In embodiments, the electronic protective surface comprises an ESD protective surface, an RFID blocking surface, or a combination thereof.

Thus, in embodiments, a reusable container herein comprises a folder having sections therein, wherein the folder sections comprise one or more of the at least one electronic interior compartment for containing an electronic article; and one or more of the at least one non-electronic interior compartment for containing a non-electronic article.

The reusable container may be a shipping container. The reusable container may also be employed in other ways, such as to hand carry items. For example, a sales representative may take the customized container on calls with samples.

Container 40 may be any suitable or desired shape including square, rectangular, oval, round, or any other shape or configuration. It is understood that container 40 is not limited to two interior compartments, but can include any suitable or desired number of interior compartments depending on the amount and nature of the materials to be shipped.

Interior compartments 54 and 56 can be used to contain any suitable or desired article, including electronic articles as described above. In embodiments, one of the compartments may be free of (that is, does not include) an ESD protective surface. The ESD-free compartment may be used to contain non-electronic articles such as paperwork, etc., as described above.

In a certain embodiment, a first compartment comprises an ESD compartment which contains an electronic article, part, or device and a second compartment comprises a non-ESD compartment that is free of ESD protective surface and contains any article where one does not desire or require ESD protection, such as paperwork or other objects as described herein.

Interior compartment 54 may be comprised of, or lined with, or have fused thereto, one or more coatings or materials selected in accordance with the material to be shipped. The ESD protective surface of interior compartment 54 forms an integral part of the compartment. The ESD protective surface of interior compartment 54 may be selected from any suitable or desired material, such as an anti-static material, a conductive material, a dissipative material, or a combination thereof, such as materials described hereinabove, and may be selected in accordance with the electronic article to be contained in compartment 54.

In a similar fashion, one or more additional interior compartments can be included within container 50 so that container 50 forms a single reusable container for shipping multiple electronic articles, non-electronic articles, paperwork, consumables, and the like without the need for multiple plastic bags, boxes, and the like, and which single container 50 is reusable such as to return the items or to send new items.

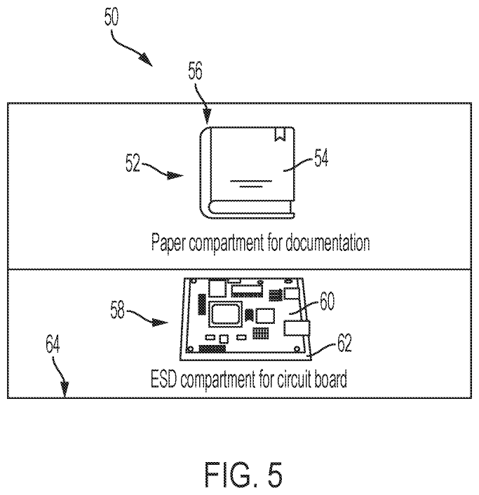

FIG. 5 is an illustration of a reusable container in accordance with the present disclosure where the container is designed for an evaluation circuit board. Container 50 may be any suitable or desired material including corrugated cardboard. Container 50 may be any suitable or desired shape including square, rectangular, oval, round, or any other configuration. It is understood that container 50 is not limited to two interior compartments, but can include any suitable or desired number of interior compartments depending on the amount and nature of the materials to be shipped. Container 50 may be in the form of a box, such as a square or rectangular box having walls such as illustrated in FIG. 4.

Container 50 includes an inner paper compartment 52 suitable for containing documentation 54. A section 56 may be included comprising an integral flap or piece forming a space within compartment 52 for holding and organizing documentation 54. Alternately, compartment 52 may contain documentation 54 therein without providing sub-section 56. Container 50 also includes an inner ESD compartment 58 suitable for containing circuit board 60. ESD compartment 58 includes an ESD surface 64 which forms an integral part of one or more interior walls of container 50 to provide ESD protection to circuit board 60. Thus, the circuit board 60 is contained within the ESD compartment 58 itself without the use of any interior bag as previously required. The ESD compartment 58 may be lined with an antistatic coating or protective material 64. Alternately, all or part of the interior wall of compartment 58 may itself comprise (that is be made of) an ESD coating or protective material.

The container 50 is reusable. After reviewing documentation 54, a recipient may, for example, write comments and return the documentation to paper compartment 52 or insert other paperwork into paper compartment 52. In addition, such as after evaluation, the circuit board 60 may be returned to the ESD compartment 58. Container 50 may then be sent back to the company.

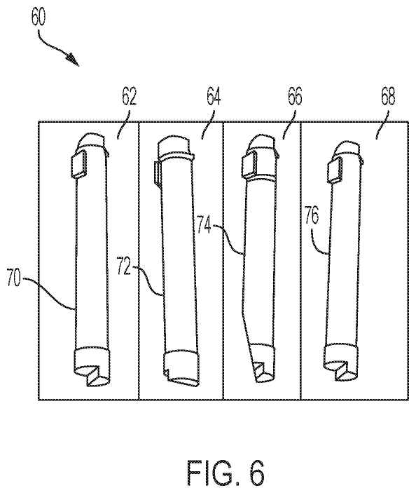

FIG. 6 is an illustration of a reusable container in accordance with the present disclosure where the container is designed to ship toner cartridges. Container 60 may be any suitable or desired material including a corrugated cardboard. Container 60 may be any suitable or desired shape, such as a square or rectangular box having walls such as illustrated in FIG. 4, although not limited. It is understood that container 60 is not limited to four interior compartments, but can include any suitable or desired number of interior compartments depending on the amount and nature of the materials to be shipped. Container 60 may be included as part of a larger reusable container which further includes electronic interior compartments in addition to the toner cartridge compartments.

In the embodiment illustrated in FIG. 6, container 60 includes four interior compartments 62, 64, 66, and 68 for containing toner cartridges, such as yellow, cyan, magenta, and black toner cartridges 70, 72, 74, 76. A customer receives the toner cartridges in container 60, and can send back empty toner cartridges in container 60 for refill or credit on their next order.

In embodiments, a method for using a reusable container for electronic articles herein comprises employing a reusable container including an exterior formed of exterior surfaces; an interior formed of interior surfaces; at least one electronic interior compartment for containing an electronic article; at least one non-electronic interior compartment for containing a non-electronic article; wherein an interior surface of the at least one electronic compartment comprises an ESD protective surface selected for the electronic article; and wherein the protective surface is an integral part of the container; and wherein the non-electronic interior compartment does not include an ESD protective surface; inserting one or more electronic articles into one or more of the at least one electronic interior compartments; inserting one or more non-electronic articles into the one or more of the at least one non-electronic interior compartments; transporting the reusable container to a first location; removing one or more of the electronic articles or non-electronic articles; refilling one or more of the at least one electronic interior compartments or the at least one non-electronic interior compartments; and transporting the reusable container to a second location.

The reusable container may be employed multiple times for multiple uses. The method herein may include inserting, refilling, and transporting including replacing contents and reusing the container two or more times. Transporting may include shipping, hand carrying, or other transporting method.

The method may be employed with any of the embodiments of the reusable container as described hereinabove. In embodiments, the method includes wherein the electronic article is selected from the group consisting of a network card, a memory card, a hard drive, a power supply, a battery, a mother board, and combinations thereof; and wherein the non-electronic article is selected from the group consisting of paperwork, instructions, invoices, ink, toner, cartridges, and combinations thereof.

In embodiments, the method herein includes wherein the reusable container comprises a member of the group consisting of a compartmented crate, a compartmented bag, a compartmented folder, a compartmented box, or a combination thereof.

In embodiments, the method herein includes wherein the ESD protective surface comprises an anti-static material, a conductive material, a dissipative material, or a combination thereof.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A reusable container for electronic articles comprising:
an exterior formed of exterior surfaces;
an interior formed of interior surfaces;
at least one electronic interior compartment for containing an electronic article;
at least one non-electronic interior compartment for containing a non-electronic article;
wherein an interior surface of the at least one electronic compartment comprises an electronic protective surface; and wherein the electronic protective surface is an integral part of the container; and
wherein the non-electronic interior compartment does not include an electronic protective surface.

2. The reusable container of claim 1, wherein the electronic protective surface comprises an ESD protective surface, an RFID blocking surface, or a combination thereof.

3. The reusable container of claim 1, wherein the electronic protective surface comprises an ESD protective surface comprising an anti-static material, a conductive material, a dissipative material, or a combination thereof.

4. The reusable container of claim 1, wherein the electronic protective surface comprises an RFID blocking surface comprising aluminum, alloy nickel, copper, or a combination thereof.

5. The reusable container of claim 1, wherein the at least one electronic interior compartment includes a flap or extension portion;
wherein the flap or extension portion forms one or more sections or sub-compartments for separating or organizing one or more electronic articles;
wherein the flap or extension portion is an integral part of the container; and
wherein the flap or extension portion includes the electronic protective surface on at least one surface of the flap or extension portion adjacent to the electronic article.

6. The reusable container of claim 1, wherein the electronic article is an electronic part or electronic device.

7. The reusable container of claim 1, wherein the electronic article is selected from the group consisting of a network card, a memory card, a hard drive, a power supply, a battery, a mother board, and combinations thereof.

8. The reusable container of claim 1, wherein the at least one non-electronic interior compartment for containing a non-electronic article contains a non-electronic article selected from the group consisting of paperwork, instructions, invoices, ink, toner, cartridges, and combinations thereof.

9. The reusable container of claim 1, wherein the at least one non-electronic interior compartment for containing a non-electronic article includes a flap or extension portion;
wherein the flap or extension portion is an integral part of the container;
wherein the flap or extension portion forms sections for separating or organizing one or more non-electronic articles; and
wherein the flap or extension portion does not include an electronic protective surface.

10. The reusable container of claim 1, wherein the reusable container is square, rectangular, oval, or round shaped.

11. The reusable container of claim 1, wherein the reusable container is formed from cardboard, corrugated cardboard, plastic, wood, or a combination thereof.

12. The reusable container of claim 1, wherein the reusable container comprises a crate, a bag, a folder, a file folder, or a box.

13. The reusable container of claim 1, wherein the reusable container comprises a folder having sections therein, wherein the folder sections comprise:
one or more of the at least one electronic interior compartment for containing an electronic article; and
one or more of the at least one non-electronic interior compartment for containing a non-electronic article.

14. The reusable container of claim 1, wherein the reusable container comprises a member of the group consisting of a compartmented crate, a compartmented bag, a compartmented folder, a compartmented box, or a combination thereof.

15. The reusable container of claim 1, wherein the reusable container comprises a shipping container.

16. A method for using a reusable container for electronic articles, the method comprising:
employing a reusable container including an exterior formed of exterior surfaces; an interior formed of interior surfaces; at least one electronic interior compartment for containing an electronic article; at least one non-electronic interior compartment for containing a non-electronic article; wherein an interior surface of the at least one electronic compartment comprises an electronic protective surface selected for the electronic article; and wherein the protective surface is an integral part of the container; and wherein the non-electronic interior compartment does not include an electronic protective surface;
inserting one or more electronic articles into one or more of the at least one electronic interior compartments;
inserting one or more non-electronic articles into the one or more of the at least one non-electronic interior compartments;
transporting the reusable container to a first location;
removing one or more of the electronic articles or non-electronic articles;
refilling one or more of the at least one electronic interior compartments or the at least one non-electronic interior compartments; and transporting the reusable container to a second location.

17. The method of claim 16, wherein the inserting, refilling, and transporting includes replacing contents and reusing the container two or more times.

18. The method of claim 16, wherein transporting comprises shipping, hand carrying, or a combination thereof.

19. The method of claim 16, wherein the electronic article is selected from the group consisting of a network card, a memory card, a hard drive, a power supply, a battery, a mother board, and combinations thereof; and
wherein the non-electronic article is selected from the group consisting of paperwork, instructions, invoices, ink, toner, cartridges, and combinations thereof.

20. The method of claim 16, wherein the reusable container comprises a member of the group consisting of a compartmented crate, a compartmented bag, a compartmented folder, a compartmented box, or a combination thereof.
